(19) United States
(12) Patent Application Publication
(10) Pub. No.: US 2025/0320111 A1
(43) Pub. Date: Oct. 16, 2025

(54) COOKING OIL EXCHANGE STATIONS, SYSTEMS AND METHODS OF USE

(71) Applicant: Restaurant Technologies, Inc., Mendota Heights, MN (US)

(72) Inventors: Michael James Zweber, Burnsville, MN (US); Radu Nicolae Simpetrean, Red Wing, MN (US)

(21) Appl. No.: 19/173,906

(22) Filed: Apr. 9, 2025

Related U.S. Application Data
(60) Provisional application No. 63/633,885, filed on Apr. 15, 2024.

(51) Int. Cl. B67D 7/82; A47J 37/12; B67D 7/02; B67D 7/78

(52) U.S. Cl. CPC B67D 7/82; A47J 37/1271; B67D 7/02; B67D 7/78

(57) ABSTRACT

A fill station, fluid exchange system, and method for exchanging of cooking oil from a location having stationary tanks containing bulk fluids are housed employ a fill box with a housing defining an interior; a first port and a second port arranged in the interior of the housing, the first port being fluidly coupled to a first stationary tank, and the second port being fluidly coupled to a second stationary tank, and a heating fluid conduit of a heating system arranged in the interior of the housing. The heating fluid conduit is configured to circulate heating fluid to supply radiant heat to the interior of the fill box to maintain cooking oil in the ports in a liquid phase. Heat may be retained within the housing interior by an insulating barrier arranged therein.

### CROSS-REFERENCE TO RELATED APPLICATION

This application claims priority to U.S. Provisional Patent Application No. 63/633,885, filed Apr. 15, 2024, entitled “Cooking Oil Exchange Stations, Systems and Methods of Use,” which is incorporated by reference herein, in the entirety and for all purposes.

### TECHNICAL FIELD

Fill stations, systems and methods provide for the exchange of cooking oil at a receiving location in which at least two stationary tanks containing bulk fluids are housed.

### BACKGROUND

Bulk delivery of cooking oil can provide a cost effective way to furnish oil for a facility, such as a fast food restaurant. However, there are problems associated with providing bulk oil. For instance, bulk delivery and retrieval can result in used and fresh cooking oil being stored at the facility over periods of time that can lead to fouling tanks, presenting challenges for removal and exchange of cooking oil.

### SUMMARY

Implementations provide a fill station for exchange of cooking oil from a location in which at least two stationary tanks containing bulk fluids are housed, the fill station including: a fill box arranged at the location, the fill box including a housing defining an interior; a first port and a second port arranged in the interior of the housing, where the first port may be fluidly coupled to a first stationary tank of the at least two stationary tanks, and the second port may be fluidly coupled to a second stationary tank of the at least two stationary tanks; an insulating barrier arranged within the interior; and a heating fluid conduit of a heating system arranged in the interior, the heating fluid conduit configured to circulate heating fluid to supply radiant heat to the interior of the fill box.

In other implementations, a fluid exchange system may be provided with a first stationary tank; a second stationary tank; a fill box with a housing defining an interior, a first port and a second port within the interior, where the first port may be fluidly coupled to the first stationary tank, and the second port may be fluidly coupled to the second stationary tank; and a heating system including a plurality of heating fluid conduits. A first heating fluid conduit of the heating system may be arranged in the interior, the first heating fluid conduit configured to circulate heating fluid to supply radiant heat to the interior of the fill box. A second heating fluid conduit of the heating system may surround an exterior of the first stationary tank.

In various aspects of the fill station and fluid exchange system, a door may be provided and configured to be opened and closed to permit access to the first and second ports. The door may include the insulating barrier, and/or may be configured to lock the fill box when closed. The heating fluid conduit may be arranged between the insulating barrier and the first and second ports. The fill box may be arranged in an area accessible to a wheeled fluid delivery vehicle. The insulating barrier may be coupled to the housing. The insulating barrier may be formed of a material selected from the group consisting of: polystyrene, polyethylene, nitrile, polychloroprene (neoprene), mineral wool and fiberglass. The heating system may include a reservoir; a heating element configured to heat the reservoir; and a recirculation pump configured to circulate heating fluid to the heating fluid conduit.

In further aspects of the fluid exchange system, an insulating material may surround the exterior of the first stationary tank, around the second heating fluid conduit; a third heating fluid conduit of the heating system may surround an exterior of the second stationary tank; an insulating material may surrounds the exterior of the second stationary tank, around the third heating fluid conduit; and/or another heating fluid conduit may be within an interior of the first stationary tank. The heating system may be further configured to circulate heating fluid additionally to the second heating fluid conduit.

In addition or alternatively, a first hose may extend between the first stationary tank and the first port; a second hose may extend between the second stationary tank and the second port; and a third heating fluid conduit extending along the first hose and the second hose. The first hose, the second hose, and the third heating fluid conduit may be surrounded with an insulating material.

Methods of heating a fluid exchange system, may involve providing a fill box with a first heating fluid conduit configured to receive a heating fluid within a housing of the fill box, where the fill box includes a first port fluidly coupled to a first stationary tank and a second port fluidly coupled to a second stationary tank; and circulating the heating fluid through the first heating fluid conduit to supply radiant heat to an interior of the fill box.

Insulation may be provided within the interior of the housing of the fill box such that upon circulating the heating fluid through the first heating fluid conduit, the radiant heat may be retained within the interior of the fill box; an insulating barrier may be provided on a door of the fill box; the first heating fluid conduit may be provided by arranging the first heating fluid conduit between the insulating barrier and the first and second ports; insulating the interior of the housing may involve coupling the insulating material to the housing. In some cases, methods may further involve providing a second heating fluid conduit, configured to receive the heating fluid, around an exterior of the first stationary tank. The exterior of the first stationary tank may be subjected to insulating around the second heating fluid conduit with a second insulating material. A third heating fluid conduit may be provided and configured to receive the heating fluid, around an exterior of the second stationary tank. The exterior of the second stationary tank around the second heating fluid conduit may be subjected to insulating with the second insulating material. A fourth heating fluid conduit may be provided within an interior of the first stationary tank. In some cases, methods may further involve providing a hose bundle by: extending a first hose between the first port and the first stationary tank; extending a second hose between the second port and the second stationary tank; and extending a second heating fluid conduit along the first hose and the second hose, the second heating fluid conduit fluidly coupled to the first heating fluid conduit. The hose bundle may be subjected to insulating with an insulating material that surrounds the first hose, the second hose, and the fifth heating fluid conduit.

### BRIEF DESCRIPTION OF THE DRAWINGS

FIG. 1 illustrates a fill station at a receiving location according to implementations of the present disclosure.

FIG. 2a illustrates aspects of a heating system in connection with the fill station of FIG. 1 according to the present disclosure.

FIG. 2b illustrates further aspects of the fill station of FIG. 1 according to the present disclosure.

FIG. 3 illustrates further aspects of the heating system according to the present disclosure.

### DETAILED DESCRIPTION

Certain details are set forth below to provide a sufficient understanding of embodiments of the disclosure. It will be clear to one skilled in the art, however, that embodiments of the disclosure may be practiced without various aspects of these particular details. In some instances, well-known circuits, control signals, timing protocols, computer system components, and software operations have not been shown in detail in order to avoid unnecessarily obscuring the described embodiments of the disclosure.

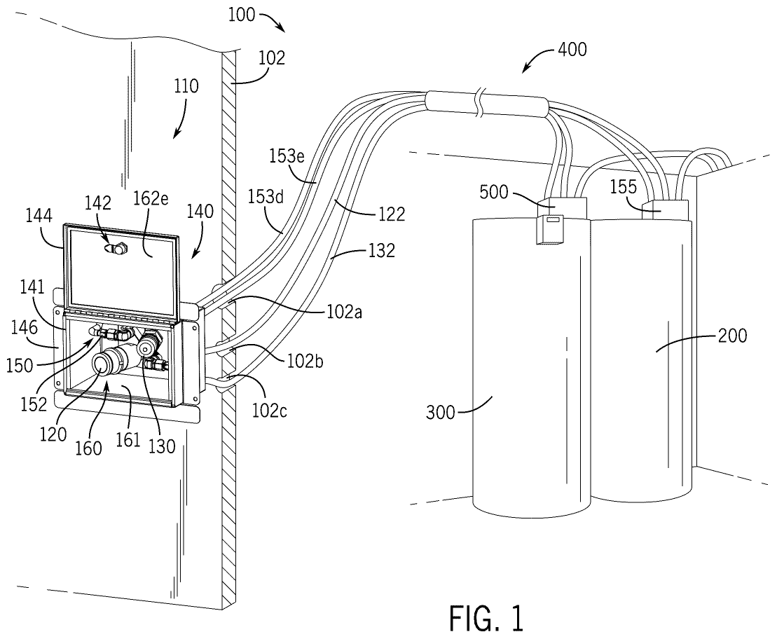

Provided are devices, systems and methods for supplying and removing cooking oil from an oil receiving location using the fill stations of the present disclosure. The oil receiving location or facility 100 may generally include a facility with one or more kitchens having at least one deep fryer 101, such as a fast-food restaurant, an entertainment center, a casino, a hotel, and so on. The receiving facility 100, as shown in FIG. 1, has a fill station 110 fluidly coupled to a stationary waste cooking oil tank 200 and a stationary fresh cooking oil tank 300. The function of the fill station 110 is to exchange of cooking oil from the location 100 where at least the two stationary tanks 200, 300 are located, e.g., housed. The function of the waste cooking oil tank 200 is to store used cooking oil for its subsequent removal from the oil receiving facility 100. The function of the fresh cooking oil tank 300 is to store fresh cooking oil and to provide fresh oil to fryers 101 for use in the cooking process. The tanks 200/300 may be configured for storage of cooking oil and generally hold 100-150 gallons or more of cooking oil. However, tanks holding other amounts of cooking oil are appropriate to use as well. The tanks 200, 300 may be fluidly connected with the fryers 101 for delivery of fresh cooking oil and removal waste oil. The tanks 200, 300 may be configured with customary level sensors configured to sense a level of cooking oil therein to facilitate the efficient exchange of cooking oil at the receiving facility 100 via the use of the fill station 110. The tanks 200, 300 may be connected to a pump assembly 500, which has at least one pump for moving the cooking oil from the one or more fryers 101 to the waste cooking oil tank 200 during a draining operation and from the fresh cooking oil tank 300 to the fryer 101 during a filling operation. In some implementations, one or more of the tanks 200, 300 may be located at the facility 100 but may be arranged at an exterior and the fill station 110 may be mounted to the tank.

As illustrated in FIG. 1, the stationary waste and used cooking oil tanks 200, 300 are each coupled with a piping system 400 within the receiving facility 100. The piping system 400 is also coupled with the fill station 110 at a location accessible from outside of the oil receiving facility 100.

For access to the stationary waste and used cooking oil tanks 200, 300, the fill station 110 is typically mounted at an exterior wall 102 of the facility 100, but the fill station 110 may also be located within the confines of the facility 100. The fill station 110 includes an oil removal coupler 120 with a port 121 fluidly connected to the stationary waste cooking oil tank 200 via a waste oil conduit 122, and an oil distribution coupler 130 with a port 131 fluidly connected to the stationary fresh cooking oil tank 300 via a fresh oil conduit 132. The function of the oil removal coupler 120 is for removal of the used cooking oil from the cooking oil tank 200. The function of the oil distribution coupler 130 is to deliver fresh cooking oil to the fresh cooking oil tank 300. The couplers 120, 130 may be configured as a quick couplers or quick connects. In some implementations, the couplers 120, 130 are different sizes and/or have different coupling configurations to prevent incorrect connections. The fill station 110 via the couplers 120, 130, may be used to exchange cooking oil contained in a transport vehicle, e.g., a truck transporting oil, and the used cooking oil may be pumped from the waste cooking oil tank 200 into the transport vehicle, and fresh cooking oil may be pumped into the fresh cooking oil tank 300 from the transport vehicle.

A housing 140 (e.g., enclosure) of the fill station 110 may include a lock mechanism 142 (e.g., a key latch). The housing 140 may be constructed of metal, e.g., aluminum or stainless steel, and configured to enclose the couplers 120, 130 within walls 141 thereof. A cover 144 of the housing 140 may include a component of the lock mechanism 142 for fastening the cover 144 to the walls 141 forming a main body. A wall mounted flange 146 may be used to mount the housing 140 to a wall 102 of the facility 100 such that the fill station 110 is recessed within the wall 102. Alternatively, the fill station 110 may be mounted to an exterior of the wall 102. Openings such as one or more through holes 102a, 102b, 102c may be defined in the wall 102 for receiving heating fluid conduits from the fill station 110, e.g., as shown in the wall 102 of FIG. 1. The lock mechanism 142 restricts access to the couplers 120, 130 and thus the tanks 200, 300 to prevent unauthorized access or tampering to the cooking oil at the facility 100. The housing 140 may accordingly be configured as a lock box.

A heating system 150 may be provided in connection with the housing 140 according to implementations of the present disclosure. The heating system 150 may be configured to provide hydronic heat and include a heating fluid conduit 152 within the housing 140 that functions to provide radiant heat to the interior of the housing where the couplers 120, 130 are enclosed. The heating system 150 may thereby maintain cooking oil contained therein at a flowable temperature. More particularly, when the ports of the couplers 120, 130 contain used and fresh cooking oil comprised of vegetable oils and tallows, these tend to solidify at lower temperatures compared to other cooking oils, which presents challenges in pumping cooking oil from the facility 100. By providing the heating system 150 according to the present disclosure, heated fluid may flow through the heating fluid conduit 152 during operation of the heating system 150 resulting in radiant heat in the housing 140 maintaining the cooking oil at a temperature that maintains a liquid phase. In some implementations, the heating system 150 may additionally be configured to provide heat via an electrical source, such as by using heating cables in place of or in addition to one or more heating fluid conduits of the recirculation loop 153 provided herein.

An insulation system 160 may also be provided in connection with the housing 140 of the fill station 110, according to implementations of the present disclosure. The insulation system 160 may include insulating material 161 within the housing 140 and function as an insulating barrier to retain heat within the interior of the housing 140 and prevent cooling of the interior from the external environment. The heating conduits of the heating system 150 may be arranged between the insulation 160 and the couplers 120, 130. For instance, the insulation 160 may be coupled to interior walls if the housing 140 such that the insulation 160 defines an enclosure for enclosing the couplers 120, 130 with a configuration substantially similar to that of the housing 140, and the heating conduits may be arranged within the enclosure proximate to and at least partially surrounding the couplers 120, 130 as provided further herein. Insulation 160 may also be provided on an interior of the cover 144 of the housing 140. Where the housing 140 is box shaped, the insulation 160 may thus provide insulation on at least five of six sides of a box-shaped enclosure, e.g., while the sixth side may include the wall 102 of the facility 100. Optionally, the housing 140 may include an external insulating system that surrounds an exterior of the housing to prevent cooling of the interior of the housing from the external environment.

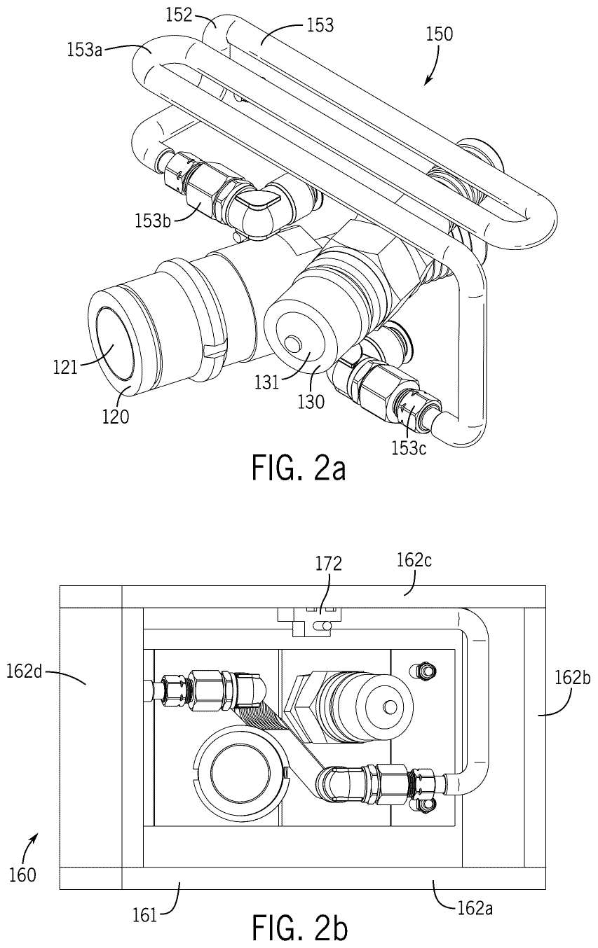

With reference to FIG. 2a, the heating fluid conduit 152 of the heating system 150 is included within a recirculation loop 153 with one or more coils 153a thereof arranged within the housing 140. The recirculation loop 153 may include a series of conduits or pipes for recirculating heating fluid therethrough, and conduits may include flexible hoses constructed of corrugated metal or polymeric material, while pipes may include rigid tubes constructed of polymeric material or metal (e.g., copper). The coils 153a may define at least a portion of the heating conduit 152 and may have any of the aforementioned configurations, however, coils 153a constructed of rigid tubes constructed of polymeric material may be preferred. The coils 153a may at least partially surround the couplers 120, 130 within the housing 140 and may have a configuration that permits access to the couplers 120, 130 when the housing cover 144 is open. Fluid couplers 153b, 153c of the recirculation loop 153 may provide a coupling of the heating conduit 152 within the housing 140 to other heating fluid conduits 153d, 153e (e.g., FIG. 1) of the recirculation loop 153. In some cases, the fluid couplers 153b, 153c may be configured with threaded and/or push to connect fittings. The other heating fluid conduits 153d, 153e may be coupled to inlet and outlet ports of a recirculation pump 155 (e.g., FIG. 1) of the heating system 150 a further provided herein. The heating fluid conduits 153d, 153e may have any of the aforementioned configurations of the conduits or pipes of the recirculation loop, however, flexible hoses constructed of polymeric material may be preferred.

With reference to FIG. 2b, illustrated is the insulation system 160 and its insulation material 161 configured to be arranged within the interior of the housing 140, but with the housing 140 not shown. In FIG. 2b, four panels 162a, 162b, 162c, 162d are provided that are composed of the insulation material 161. Each of the panels 162a-162d may be coupled to an interior wall of the housing 140, e.g., with adhesive and/or fasteners. In some implementations, the insulation material 161 may be an insert instead of panels and the insert may be configured to be received in the housing 140 and to surround the couplers 120, 130 substantially similarly as shown in FIGS. 1 and 2b. In addition, a fifth panel 162e (FIG. 1) may be provided on the cover 144 of the housing 140. The insulation material may be formed of insulating foam such as polystyrene, polyethylene, nitrile, polychloroprene (neoprene), mineral wool and fiberglass. Insulation material 161 may optionally be provided against the wall 102 of the facility 100 and may define openings for passage of the oil conduits of the couplers 120, 130 and the heating fluid conduits 153d, 153e joined to the heating fluid conduit 152 within the housing 140. Depending on the makeup of the insulation material 161, a coating or cover may be provided on one or more surfaces of the insulation material 161, e.g., on a surface facing the interior of the housing, which may resist absorption of oil. The couplers 120, 130 may be generally free of the insulation material 161 due to the need for the couplers 120, 130 to couple to the fluid lines of a transport vehicle for the exchange process to occur.

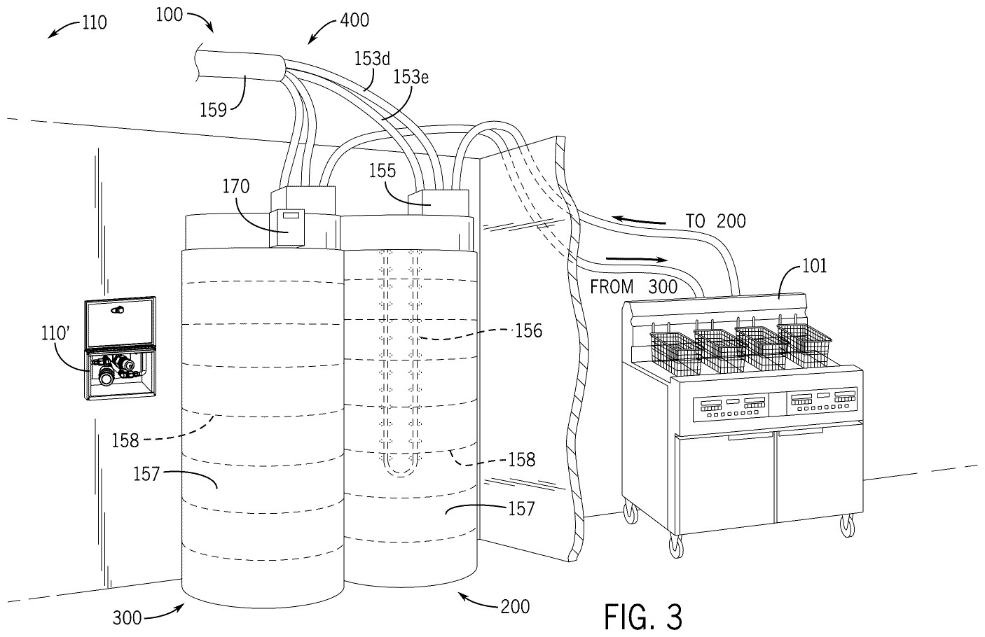

With reference to FIG. 3, illustrated is the recirculation pump 155 of heating system 150, along with other components that may optionally be used in connection with the heating system 150 of the present disclosure. In FIG. 3, the recirculation pump 155 may be configured with a heating element, a thermostat, a pump, a reservoir for containing heating fluid, and ports for coupling to the recirculation loop 153, e.g., via the heating fluid conduits 153d, 153e. The heating element and the thermostat of the recirculation pump 155 may function to maintain the heating fluid at a desired temperature, and the pump may function to recirculate the heating fluid through the recirculation loop 153. The heating fluid may be a mixture of water and propylene glycol. In some implementations, the temperature of the heating fluid in the recirculation loop may be maintained at a temperature sufficient to maintain the temperature of the cooking oil higher than its solidification temperature, such as about or higher than 10-30° F. above the solidification temperature, or the heating fluid may be maintained at a temperature range of between about 80 to about 200° F., about 100 to about 160° F., or about 115 to about 140° F. The pump continuously circulates the heating fluid through the recirculation loop 153 such that the heating conduit 152 within the housing 140 provides radiant heat to the interior of the housing 140 to thereby maintain the cooking oil in the couplers 120, 130 in a liquid state.

In some implementations, the heating system 150 may additionally include an internal tank heater coil 156, one or more heater blankets 157, recirculation conduits 158, and/or an insulated hose bundle 159 leading to the heating conduit 152 in the fill station 110 as well as to other locations of the facility 100.

The internal tank heater coil 156 may be provided in one or both tanks 200, 300. Such internal heater coils are commonly arranged in tanks holding waste oil, such as tank 200. The internal tank heater coil 156 may be configured as a metal (e.g., copper) coil and may extend into the oil contained within the tank to permit the heating fluid to flow through the coil. The recirculation pump 155 may circulate the heating fluid through the internal tank heater coil 156 and heat the oil within the tank.

The one or more heater blankets 157 may be wrapped around an exterior of a cooking oil tank. The heater blankets may be constructed of insulating material, which may be the same or different from the insulation material 161. The heater blanket 157 may include an exterior layer or coating, which may be constructed of a polymer such as polyvinyl chloride (PVC), polychloroprene (Neoprene) or polyamide (Nylon) and function to retain heat and protect the tank from sparks and fire. An interior layer may be defined at least in part by the insulating material, which may include polyethylene, nitrile, polychloroprene, mineral wool, fiberglass and function to retain heat. The heater blanket 157 may be wrapped around a circumference of the tank substantially along an entire length of the tank and ends of the heater blanket 157 may be secured to each other such as by ties or fasteners.

The recirculation conduits 158 may be configured as a series of fluidly connected hoses containing the heating fluid that may be pressed against the exterior of the cooking oil tank. Accordingly, the recirculation conduits 158, or fluidly connected hoses, may be made from flexible tubing (e.g., PEEK). When used in combination with the heater blanket 157, the recirculation conduits 158 may be arranged between an interior facing side of the heater blanket 157 and an exterior of the cooking oil tank, and for instance the recirculation conduits 158 may be held against the tank by the heater blanket 157. The recirculation conduits 158 are illustrated as rows of hoses encircling the tanks 200, 300 but the hoses may have a variety of configurations and for instance may define a lattice for encircling one or both tanks. Where the recirculation conduits 158 collectively define a sheet or layer of hoses, the sheet or layer of hoses may be wrapped around the tank and secured at the ends so that the hoses wrap around the circumference and contact the exterior sidewall of the tank. The recirculation conduits may be provided around substantially the entire circumference of and along substantially the entire length of the tank. The recirculation pump 155 may circulate the heating fluid through the recirculation conduits 158 to provide radiant heat onto the exterior of the tanks, while the heater blanket 157, when present, provides insulation to retain heat in the tank(s) and recirculation conduits 158. In some implementations, the heater blanket 157 and recirculation conduits 158 may be provided around one of the tanks 200 or 300, while in other implementations, each of the tanks 200 and 300 may include the heater blanket 157 and recirculation conduits 158.

Insulated hose bundles 159 may include insulation placed over the hose bundles that fluidly couple the cooking oil tanks 200, 300 to the fryers 101, the fill station 110 and other locations within the facility 100 where cooking oil is transported. Hoses within the hose bundle may be made from a flexible tubing such as flexible corrugated metal tubing, nitrile, polyvinyl chloride, polytetrafluoroethylene (Teflon) and/or polyethylene. Hose bundles generally include the fresh and waste oil conduits as well as the heating fluid conduits of the heating system 150, and the insulation may be placed over these conduits to provide the insulated hose bundles 159. This may permit the heating fluid conduits of the heating system 150 to keep the cooking oil conduits in the bundle warm, while the insulation functions to retain heat inside the bundles. The insulated hose bundles 159 may be provided throughout the facility 100 along all or a portion of the piping system 400. For instance, oil conduits to the fryers 102 and/or a secondary fill station 110′ may be bundled with heating conduits and be contained in insulated hose bundles 159. While prior approaches employ the internal tank heater coil 156 within cooking oil storage tanks, providing the heating system 150 according to the various aspects of the present disclosure may facilitate maintaining cooking oil stored within the facility 100 above the solidification temperature more consistently across the oil couplers, ports, conduits, and storage tanks.

The secondary fill station 110′ (FIG. 3) within the facility 100 may be configured similarly to the fill station 110 of FIG. 1. For instance, the secondary fill station 110′ may include the heating conduit 152 within the housing fluidly coupled to the recirculation loop 153 of the heating system 150, and may optionally include an insulation system 160. Oil conduits from the secondary fill station 110′ to the tanks 200, 300 may be bundled with heating conduits and contained in insulated hose bundles 159. The couplers 120, 130 of the secondary fill station may have a configuration for fluidly coupling to a transport vehicle, which may be the same or different from the transport vehicle, e.g., delivery truck, described in connection with FIG. 1. For instance, the transport vehicle servicing the secondary fill station 110′ may be a wheeled portable cart for use in transporting cooking oil within the facility. In such cases, the couplers 120, 130 may be sized to receive complementary couplers carried by the wheeled portable cart, and for instance a portable tank of the wheeled portable cart may contain used cooking oil that may be pumped into the waste cooking oil tank 200 via the secondary fill station 110′, and/or fresh cooking oil may be pumped from the fresh cooking oil tank 300 via the secondary fill station 110′ into a portable tank of the wheeled portable cart.

The various heating fluid conduits of the heating system 150 may be incorporated into the recirculation loop 153 and contain heating fluid circulated by the recirculation pump 155. For instance, the heating fluid conduits 153d, 153e may be fluidly coupled to the recirculation conduits 158 surrounding the tanks, and the recirculation pump 155 may pump the same supply of heating fluid through these conduits. In some cases the internal tank heater coil 156 may be fluidly coupled to the heating fluid conduits 153d, 153e, in addition or as an alternative to the recirculation conduits 158. Accordingly, the heating fluid conduits may share the same supply of heating fluid. Alternatively, multiple supplies of heating fluid may be circulated by the recirculation pump 155. In some cases, multiple recirculation pumps 155 may be provided for recirculating heating fluid in one or more recirculation loops 153. As may be appreciated from the foregoing, the heating system 150 and its heating fluid conduits may be arranged external to the conduits carrying the cooking oil, and for instance, the conduits carrying the cooking oil may be free of internal heating elements.

A control box 170 may implement aspects of a control system of the facility 100. The control box 170 may be arranged at the facility 100 and be configured with programming and electronics for evaluating a condition of the heating system 150, the tanks 200, 300, and/or the pump system 500. For instance, the control box 170 may be communicatively coupled to temperature sensors for determining whether the heating system 150 is maintaining the cooking oil at the desired temperature, e.g., within the housing 140 of the fill station 110, within the tanks 200, 300, within the insulated hose bundles 159, and so on. The control box 170 may also have customary configurations for communicating with level sensors in the tanks 200, 300 for determining when the tanks require servicing, and so on. In some implementations, the control box may supply power to the various components, such as the recirculation pump 155 and the pump system 500, while in other cases, various components may be independently powered, e.g., via conventional power source. An electrical connector 172 (FIG. 2b) may be provided in the housing 140 of the fill station 110 and, for instance when coupled to a connector of the transport vehicle, may provide information about the level of oil within the fresh oil tank 300, e.g., via a tank level switch, during the filling process. In some cases, the control box 170 may be communicatively coupled to the electrical connector 172 and the tank level switch.

It will be appreciated that the examples of the heated fill station 110 are exemplary, and that the components of the heated fill station 110, the heating system 150, insulation system 160, and control box 170 may be arranged differently, or may include fewer or additional components, without departing from the scope of the disclosure.

The previous description of the disclosed embodiments is provided to enable a person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as previously described.

What is claimed is:

1. A fill station for exchange of cooking oil from a location in which at least two stationary tanks containing bulk fluids are housed, the fill station comprising:
a fill box arranged at the location, the fill box comprising a housing defining an interior;
a first port and a second port arranged in the interior of the housing, wherein the first port is fluidly coupled to a first stationary tank of the at least two stationary tanks, and the second port is fluidly coupled to a second stationary tank of the at least two stationary tanks;
an insulating barrier arranged within the interior; and
a heating fluid conduit of a heating system arranged in the interior; the heating fluid conduit configured to circulate heating fluid to supply radiant heat to the interior of the fill box.

2. The fill station of claim 1, wherein the fill box comprises a door configured to be opened and closed to permit access to the first and second ports.

3. The fill station of claim 2, wherein the door comprises the insulating barrier.

4. The fill station of claim 1, wherein the heating fluid conduit is arranged between the insulating barrier and the first and second ports.

5. The fill station of claim 1, wherein the fill box is arranged in an area accessible to a wheeled fluid delivery vehicle.

6. The fill station of claim 1, wherein the heating system comprises:
a reservoir;
a heating element configured to heat the reservoir; and
a recirculation pump configured to circulate heating fluid to the heating fluid conduit.

7. A fluid exchange system comprising:
a first stationary tank;
a second stationary tank;
a fill box comprising a housing defining an interior, a first port and a second port within the interior, wherein the first port is fluidly coupled to the first stationary tank, and the second port is fluidly coupled to the second stationary tank; and
a heating system comprising a plurality of heating fluid conduits,
wherein a first heating fluid conduit of the heating system is arranged in the interior, the first heating fluid conduit configured to circulate heating fluid to supply radiant heat to the interior of the fill box, and
wherein a second heating fluid conduit of the heating system surrounds an exterior of the first stationary tank.

8. The fluid exchange system of claim 7, wherein an insulating material surrounds the exterior of the first stationary tank, around the second heating fluid conduit.

9. The fluid exchange system of claim 7, wherein a third heating fluid conduit of the heating system surrounds an exterior of the second stationary tank.

10. The fluid exchange system of claim 9, wherein an insulating material surrounds the exterior of the second stationary tank, around the third heating fluid conduit.

11. The fluid exchange system of claim 7, further comprising a third heating fluid conduit within an interior of the first stationary tank.

12. The fluid exchange system of claim 7, wherein the heating system comprises:
a reservoir;
a heating element configured to heat the reservoir; and
a recirculation pump configured to circulate the heating fluid to at least the first heating fluid conduit and the second heating fluid conduit.

13. The fluid exchange system of claim 7, further comprising:
a first hose extending between the first stationary tank and the first port;
a second hose extending between the second stationary tank and the second port; and
a third heating fluid conduit extending along the first hose and the second hose.

14. A method of heating a fluid exchange system, comprising:
providing a fill box with a first heating fluid conduit configured to receive a heating fluid within a housing interior of the fill box, wherein the fill box includes a first port fluidly coupled to a first stationary tank and a second port fluidly coupled to a second stationary tank; and
circulating the heating fluid through the first heating fluid conduit to supply radiant heat to an interior of the fill box.

15. The method of claim 14, further comprising providing insulation within the housing interior such that upon circulating the heating fluid through the first heating fluid conduit, the radiant heat is retained within the housing interior.

16. The method of claim 14, wherein providing the first heating fluid conduit includes arranging the first heating fluid conduit between an insulating barrier and the first and second ports.

17. The method of claim 14, further comprising providing a second heating fluid conduit, configured to receive the heating fluid, around an exterior of the first stationary tank.

18. The method of claim 17, further comprising providing a third heating fluid conduit, configured to receive the heating fluid, around an exterior of the second stationary tank.

19. The method of claim 18, further comprising providing a fourth heating fluid conduit within an interior of the first stationary tank.

20. The method of claim 14, further comprising:
providing a hose bundle by:
extending a first hose between the first port and the first stationary tank;
extending a second hose between the second port and the second stationary tank; and
extending a second heating fluid conduit along the first hose and the second hose, the second heating fluid conduit fluidly coupled to the first heating fluid conduit.
